(19) United States
(12) Patent Application Publication
(10) Pub. No.: US 2019/0197484 A1
(43) Pub. Date: Jun. 27, 2019

(54) SEGMENTATION AND LABELING OF JOB POSTINGS

(71) Applicant: Microsoft Technology Licensing, LLC, Redmond, WA (US)

(72) Inventors: Seyedmohsen Jamali, Sunnyvale, CA (US); Samaneh Abbasi Moghaddam, Sunnyvale, CA (US)

(73) Assignee: Microsoft Technology Licensing, LLC, Redmond, WA (US)

(21) Appl. No.: 15/885,111

(22) Filed: Jan. 31, 2018

Related U.S. Application Data
(60) Provisional application No. 62/610,082, filed on Dec. 22, 2017.

(51) Int. Cl. G06Q 10/10; G06K 9/00

(52) U.S. Cl. CPC G06Q 10/1053; G06K 9/00483; G06K 9/00456; G06K 9/00463

(57) ABSTRACT

The disclosed embodiments provide a system for processing data. During operation, the system obtains a set of segments from a job posting, wherein each segment in the set of segments includes a portion of text in the job posting. Next, the system applies a model to the set of segments to produce a set of labels for the set of segments, wherein each label in the set of labels represents a type of information in the job posting. The system then stores the segments with the labels for use in matching the job posting to a candidate.

### RELATED APPLICATION

This application claims priority under 35 U.S.C. § 119 to U.S. Provisional Application No. 62/610,082, entitled “Model-Based Segmentation and Labeling of Job Postings,” by Seyedmohsen Jamali, filed 22 Dec. 2017 (Atty. Docket No.: LI-902195-US-PSP), the contents of which are herein incorporated by reference in their entirety.

### BACKGROUND

### Field

The disclosed embodiments relate to techniques for performing model-based segmentation and labeling of job postings.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

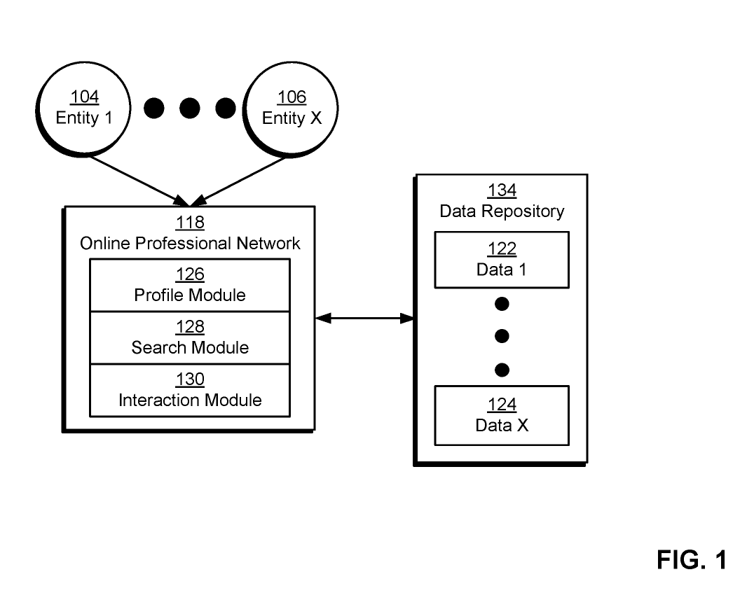

The disclosed embodiments provide a method, apparatus, and system for performing model-based segmentation and labeling of job postings. As shown in FIG. 1, the job postings may be submitted and/or viewed by members of a social network or other community, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, data in data repository 134 may be used to generate recommendations and/or other insights related to listings of jobs or opportunities within online professional network 118. For example, one or more components of the online professional network may track searches, clicks, views, text input, conversions, and/or other feedback during the entities' interaction with a job search tool in the online professional network. The feedback may be stored in data repository 134 and used as training data for one or more statistical models, and the output of the statistical model(s) may be used to display and/or otherwise recommend a number of job listings to current or potential job seekers in the online professional network.

To improve the quality or relevance of the recommendations and/or improve the user experience with searches, applications, inquiries, and/or placements of jobs or opportunities, online professional network 118 may perform model-based segmentation and labeling of postings of jobs or opportunities. In particular, online professional network 118 includes functionality to divide each posting into multiple segments representing semantically and/or structurally distinct portions of the posting. For example, segments in a job posting may include different paragraphs, lists, and/or other sub-sections of the job posting.

Online professional network 118 then generates labels for the segments, with each label identifying a type of information included in the corresponding segment. For example, segments in a job posting may be labeled as containing a company description, qualifications, requirements, roles, responsibilities, and/or benefits associated with the corresponding job. In turn, the labeled segments may be filtered and provided to machine learning models and/or inference techniques for finer-grained matching of the job postings to profile data for members of online professional network 118 and/or generation of insights based on the job postings, profile data, and/or other data in online professional network 118.

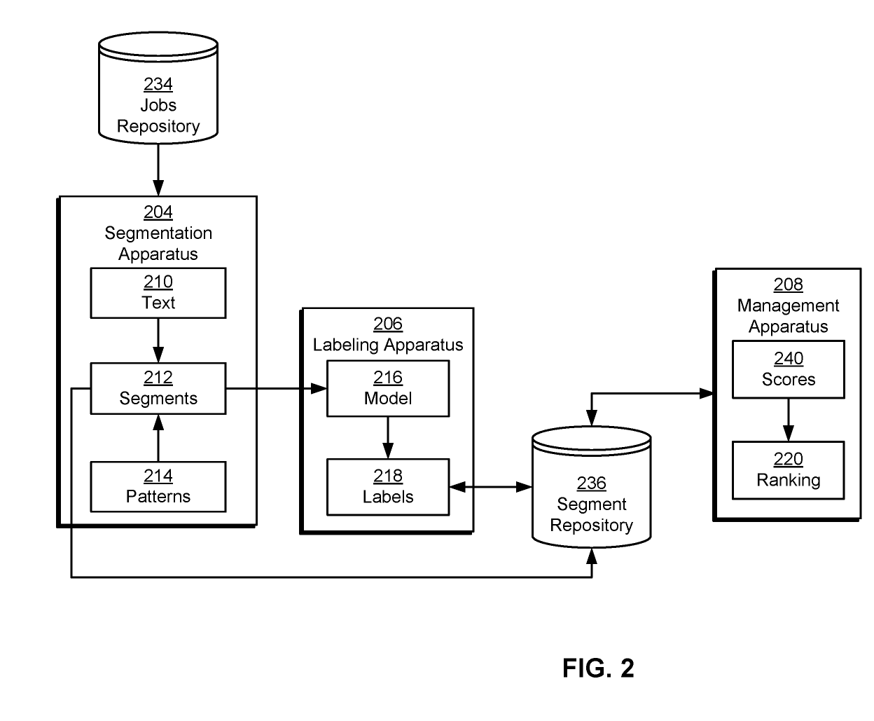

FIG. 2 shows a system for processing data in accordance with the disclosed embodiments. More specifically, FIG. 2 shows a system for performing model-based segmentation and labeling of job postings. The system includes a segmentation apparatus 204, a labeling apparatus 206, and a management apparatus 208. Each of these components is described in further detail below.

The job postings may be obtained from a recruiter, hiring manager, human resources professional, and/or another moderator involved in placing a job, position, or opportunity. The job postings may include text 210 that is provided in a variety of formats, including, but not limited to, HyperText Markup Language (HTML) documents, word-processing documents, Portable Document Format (PDF) documents, plain text, and/or other types of semi-structured and/or unstructured data. For example, the moderators may provide the job postings by uploading documents or web pages containing the job postings, copying and pasting text from the documents and/or web pages, and/or providing information in the job postings in one or more user-interface elements (e.g., text fields, text boxes, checkboxes, radio buttons, drop-down menus, etc.). The moderators may also, or instead, provide information in the job postings using images, audio, video, and/or other non-text-based content. A speech-recognition technique, optical character recognition (OCR) technique, and/or other technique for extracting text 210 from other types of data may be used to convert such types of content into a text-based format.

In turn, textual and/or non-text-based representations of the job postings may be stored in a database, filesystem, data warehouse, collection of files, cloud storage, and/or another type of data store providing a jobs repository 234. The job postings may then be displayed, recommended, and/or otherwise outputted by a social network (e.g., online professional network 118 of FIG. 1), an employment website or service, and/or another application or service that can be used to search for, view, obtain recommendations for, and/or apply for jobs or opportunities.

Segmentation apparatus 204 obtains text 210 for a given job posting from jobs repository 234 and generates a set of segments 212 from text 210. As mentioned above, segments 212 may include distinct portions of text 210 that represent or describe different aspects of the job posting. For example, segments 212 may include distinct paragraphs, sub-sections, lists, and/or other semantic or structural groupings of text in the job posting.

Prior to extracting segments 212 from text 210, segmentation apparatus 204 and/or another component of the system may perform pre-processing of text 210. For example, the component may standardize HTML tags and/or representations of line breaks or other whitespace in text 210 to facilitate subsequent identification of segments 212 using patterns 214 related to the HTML tags and/or whitespace.

More specifically, segmentation apparatus 204 generates segments 212 by matching different parts of text 210 to a set of patterns 214. Patterns 214 may include tags, regular expressions, paragraphs, and/or other representations of boundaries between segments 212 in text 210. For example, patterns 214 may include HTML tags for headers and/or heading elements, paragraphs, lists, list items (e.g., bullet points, numbered list items, alphabetically ordered list items, etc.), and/or other distinct parts of HTML documents. Patterns 214 may further include HTML tags that are used to infer the presence of headers in the absence of explicit header or heading tags, such as tags for marking text as bold or strong.

Patterns 214 may also, or instead, include regular expressions for line breaks, bullet points, and/or other representations of paragraphs, list items, and/or other distinct portions of text 210 in lieu of or in addition to HTML or other tags. An exemplary list of such patterns 214 may include, but is not limited to, the following:
“\r\n\to”
“\r\n-\t”
“\r\n\t”
“\r\n*”
“\r\n\u0095\t”
“•”
“•\t”
“,Ä¢”
“,Ä¢\t”
“&amp;Acirc;¬Σ\t”
“&amp;Acirc;¬Σ”
“-”
“-\t”

In turn, patterns 214 identified in text 210 may be used to define segments 212. For example, segmentation apparatus 204 may use patterns 214 to divide paragraphs, lists, headers, subsections, and/or other distinct portions of text 210 into separate segments 212.

One or more patterns 214 may also, or instead, be used to merge two or more segments 212 that are likely to be conceptually connected into a single segment. For example, segmentation apparatus 204 may merge two segments containing a header followed by a body into a single segment. In another example, segmentation apparatus 204 may merge two or more segments containing one or more list items (e.g., bullet points, numbered list items, etc.) that are not separated by headers and/or additional text into a single segment representing a single list.

After segments 212 are identified from text 210, labeling apparatus 206 applies a model 216 to segments 212 to produce a set of labels 218 for segments 212. Each label may represent a type of information included in the corresponding segment of text 210. For example, labels 218 for job postings may include, but are not limited to, company descriptions, benefits, roles, qualifications, requirements, and/or responsibilities. Labels 218 may further be refined to specify skills, education, work experience, and/or other types of attributes related to the roles, qualifications, requirements, and/or responsibilities.

In one or more embodiments, model 216 includes a text-mining model and/or a machine-learning model. The text-mining model may match words, phrases, and/or regular expressions in segments 212 to common and/or frequently occurring patterns associated with specific types of information in job postings. For example, the text-mining model may identify a segment as containing qualifications and/or requirements for a job based on keywords and/or phrases such as “requirement,” “qualification,” “experience with,” “experience in,” “years working in,” “years experience,” “proficient in,” “knowledge of,” “qualified,” “skill,” “required,” “preferred,” “position requires,” “required license,” “required certification,” and/or “familiarity with.” In another example, the text-mining model may identify a segment as containing a role and/or responsibilities for the job based on keywords and/or phrases such as “overview,” “role,” “position,” “job purpose,” “responsibilities,” “duties,” “duties include,” “overview,” “the role,” “what you'll do,” “we are looking for an individual,” “accountabilities,” “principal duties,” and/or “function.” Such keywords and/or phrases may be identified by applying frequency-based text-mining techniques to a large set of job postings and matching frequently occurring words or phrases from the job postings to different types of information found in the job postings.

The machine-learning model may obtain patterns, keywords, phrases, sentences, paragraphs, headers, bodies, lists, list items, and/or other types or combinations of content in segments 212 as input and generate output containing a label for each segment. For example, the machine-learning model may include a decision tree and/or other type of classifier that identifies one or more labels to be assigned to each segment based on the structure and/or content of the segment and/or the types and numbers of keywords or phrases found in the segment.

The operation of segmentation apparatus 204 and labeling apparatus 206 may be illustrated using an exemplary job posting that includes the following text 210:

Our leading insurance client located in Tampa, Fla. is currently seeking a Business Analyst for a fantastic and exciting contract opportunity. This Business Analyst provides strategic support, including data analytics of Casualty insurance claim related information, preparation of preliminary reports of findings, working directly with a team of Senior Level Consultants and Senior Management on specific client data and general analytics projects with an expectation of improving existing processes through the use of technology, and enhancing client deliverables.

Specific Duties and Responsibilities of the Business Analyst
Understanding the needs and communicating with multiple stakeholders.
Create Client reports, dynamic graphs, charts, tables and similar to reflect data analysis.
Modify data analysis output when needed based on customer request or changing market trends.
Respond accordingly to data analysis requests that are urgent in nature
Building test cases and coordinating groups of users for testing purposes.
Identifying the current and future-state business processes.
Facilitating the negotiation of requirements amongst the stakeholders.
Helping the business stakeholders envision the future and how their work will need to change to support the future.

Minimum Requirements and Experience for this Business Analyst
Experience with creating, analyzing, and validating detailed functional specifications.
Proficiency with computer systems, advanced reporting functions of MS Excel
Ability to meet deadlines; well organized and the ability to learn under mentorship
Strong written and verbal communication skills
Prior insurance experience a plus

This Business Analyst job will not last long. Our client has an aggressive timeline and is looking to hire immediately for this position. To be considered, you must apply online now and submit your resume. We are actively monitoring. Apply below!

Segmentation apparatus 204 may use patterns 214 associated with paragraphs, headers, lists, and/or other distinct portions of text 210 to identify four segments 212 from the exemplary job posting. The first segment includes the first paragraph of the job posting, the second segment includes the first header and list following the first paragraph, the third segment includes the second header and list following the first header and list, and the fourth segment includes the final paragraph of the job posting.

Next, labeling apparatus 206 may analyze words, phrases, headers, bodies, paragraphs, lists, list items, and/or other types or combinations of content in each segment to determine a label for the segment. In turn, the first and last segments may be labeled as containing a general description of the job posting (e.g., based on a lack of keywords associated with other labels), the second segment may be labeled as containing a role and/or responsibilities for the job posting (e.g., based on keywords such as “duties” and/or “responsibilities”), and the third segment may be labeled as containing requirements and/or qualifications related to the job posting (e.g., based on keywords such as “requirements,” “experience”, “proficiency,” and “skills”).

A crowdsourcing technique may be used to obtain data that is used to create and/or validate patterns 214, model 216, and/or other components for generating segments 212 and/or the corresponding labels 218. For example, a crowdsourcing platform may be used to obtain manually created segments 212 for text 210 in a set of job postings and/or verify segments 212 created by segmentation apparatus 204. The crowdsourcing platform may also, or instead, be used to obtain manually created labels 218 for segments 212 and/or verify labels 218 generated by labeling apparatus 206. In turn, the crowdsourced segments 212 and/or labels 218 may be used as data for identifying patterns 214 for defining segments 212 and/or creating, testing, and/or validating the performance of model 216 in generating labels 218 for segments 212.

After segments 212 and labels 218 are produced for a given job posting, segmentation apparatus 204 and/or labeling apparatus 206 may store segments 212 and labels 218 in a segment repository 236 for subsequent retrieval and use. For example, some or all text 210 in segments 212 may be stored with identifiers for the corresponding labels 218 in a database, filesystem, data warehouse, collection of files, cloud storage, and/or another type of data store.

Management apparatus 208 then uses segments 212 and labels 218 from segment repository 236, segmentation apparatus 204, and/or labeling apparatus 206 to generate recommendations, insights, and/or other output related to the job postings and/or entities to which the job postings may pertain. For example, management apparatus 208 may use labels 218 to retrieve, from segment repository 236, a subset of segments 212 from a given job posting that contain qualifications and/or requirements associated with the corresponding job. Management apparatus 208 may then apply a machine-learning model to features extracted from the subset of segments 212 and features related to candidates for the job to generate scores 240 representing the strength of the candidates with respect to the qualifications and/or requirements. Management apparatus 208 may further produce a ranking 220 of the candidates by scores 240 and use ranking 220 and/or scores 240 to output recommendations of job postings to candidates, recommendations of candidates for job postings, and/or the positions or percentiles of the candidates in ranking 220. In another example, management apparatus 208 may identify one or more segments 212 that list benefits of a job and match the job to candidates with preferences for those benefits.

By segmenting and labeling job postings based on patterns 214, keywords, phrases, headers, bodies, paragraphs, lists, list items, and/or other components of text 210 in the job postings, the system of FIG. 2 may automatically categorize different portions of the job postings based on the semantics and/or structure of each portion. In turn, such categorization may allow semantically distinct portions of the job postings to be identified and used to generate more targeted and/or accurate scores 240, rankings (e.g., ranking 220), and/or insights related to the portions. Consequently, the system may improve the performance and use of technologies for processing and analyzing job postings, applying machine learning or statistical inference techniques to job postings, and/or generating recommendations or insights based on the job postings, as well as the operation and use of applications and computer systems in which the technologies execute.

Those skilled in the art will appreciate that the system of FIG. 2 may be implemented in a variety of ways. First, segmentation apparatus 204, labeling apparatus 206, management apparatus 208, jobs repository 234, and segment repository 236 may be provided by a single physical machine, multiple computer systems, one or more virtual machines, a grid, one or more databases, one or more filesystems, and/or a cloud computing system. Segmentation apparatus 204, labeling apparatus 206, and management apparatus 208 may additionally be implemented together and/or separately by one or more hardware and/or software components and/or layers. Moreover, various components of the system may be configured to execute in an offline, online, and/or nearline basis to perform different types of processing related to generating and storing segments 212 and labels 218 for job postings in jobs repository 234.

Second, a number of models and/or techniques may be used to generate segments 212 and/or labels 218. For example, the functionality of segmentation apparatus 204 and/or labeling apparatus 206 may be provided by a regression model, artificial neural network, support vector machine, decision tree, naïve Bayes classifier, Bayesian network, clustering technique, collaborative filtering technique, hierarchical model, text-mining model, and/or ensemble model.

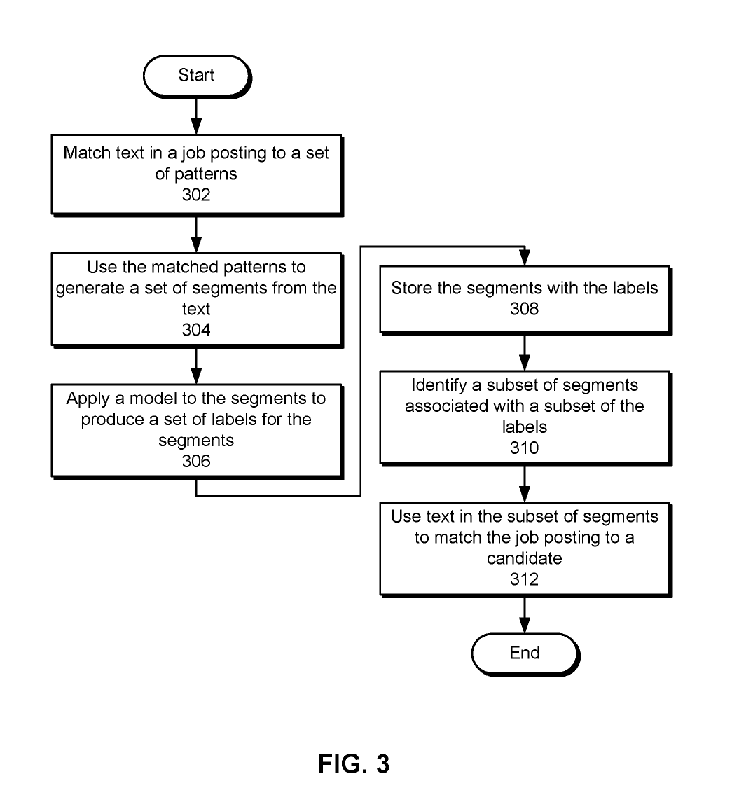

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the technique.

Initially, a set of segments is obtained from a job posting. To obtain the segments, text in the job posting is matched to a set of patterns (operation 302). For example, the text may be matched to tags, regular expressions, line breaks, and/or other representations of boundaries between the segments. In turn, the matched patterns are used to generate the segments from the text (operation 304). For example, parts of the text that match the patterns may be used to define individual segments and/or merge two or more segments into a single segment.

Next, a model is applied to the segments to produce a set of labels for the segments (operation 306). For example, one or more components of a segment may be included as input to the model, and a label for the segment may be obtained as output from the model. The component(s) may include a header, a body, a paragraph, a list, and/or a list item. The model may include a text-mining model and/or a machine-learning model. The labels are then stored with the segments (operation 308) for use in matching the job posting to a candidate.

To use the labels and segments to match the job posting to the candidate, a subset of segments associated with a subset of the labels is identified (operation 310), and text in the subset of segments is used to match the job posting to the candidate (operation 312). For example, the segments may be filtered to omit segments that aren't labeled with roles, requirements, qualifications, and/or other information that is important to placing candidates for the corresponding jobs. The remaining segments may then be analyzed to obtain skills, education, work experience, and/or other preferred or required attributes of the candidates. The attributes may then be used to improve searches, recommendations, rankings, and/or other functionality or insights related to jobs or candidates.

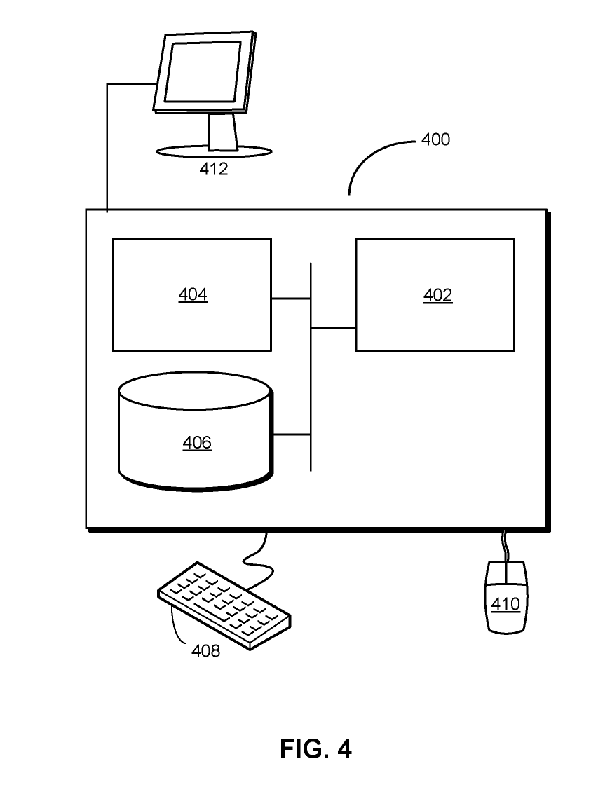

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a segmentation apparatus and a labeling apparatus, one or more of which alternatively be termed or implemented as a module, mechanism, or other type of system component. The segmentation apparatus obtains a set of segments from a job posting, with each segment containing a different portion of text in the job posting. Next, the labeling apparatus applies a model to the set of segments to produce a set of labels for the segments, with each label representing a type of information in the job posting. The segmentation and/or labeling apparatuses then store the segments with the corresponding labels for use in matching the job posting to a candidate.

In addition, one or more components of computer system 400 may be remotely located and connected to the other components over a network. Portions of the present embodiments (e.g., segmentation apparatus, labeling apparatus, jobs repository, segment repository, online professional network, etc.) may also be located on different nodes of a distributed system that implements the embodiments. For example, the present embodiments may be implemented using a cloud computing system that generates segments and labels from jobs obtained from a set of remote sources.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of segments from a job posting, wherein each segment in the set of segments comprises a portion of text in the job posting;
applying a model to the set of segments, by one or more computer systems, to produce a set of labels for the set of segments, wherein each label in the set of labels represents a type of information in the job posting; and
storing the set of segments with the set of labels for use in matching the job posting to a candidate.

2. The method of claim 1, wherein obtaining the set of segments from the job posting comprises:
matching the text in the job posting to a set of patterns; and
using the matched set of patterns to generate the set of segments.

3. The method of claim 2, wherein using the matched set of patterns to generate the segments comprises:
using a pattern to define a segment.

4. The method of claim 2, wherein using the matched set of patterns to generate the segments comprises:
using a pattern to merge two segments into a single segment.

5. The method of claim 2, wherein the set of patterns comprises at least one of:
a tag;
a regular expression; and
a line break.

6. The method of claim 1, wherein applying the model to the set of segments to produce the set of labels for the set of segments comprises:
including one or more components of a segment as input to the model; and
obtaining, from the model, a label for the segment.

7. The method of claim 6, wherein the one or more components comprise at least one of:
a header;
a body;
a paragraph;
a list; and
a list item.

8. The method of claim 1, wherein using the set of segments with the set of labels for use in matching the job posting to the candidate comprises:
identifying a subset of the segments associated with a subset of the labels; and
using text in the subset of the segments to match the job posting to the candidate.

9. The method of claim 1, wherein the set of labels comprises:
a requirement; and
a role.

10. The method of claim 9, wherein the requirement comprises at least one of:
an amount of experience;
an educational requirement; and
a skill.

11. The method of claim 1, wherein the set of labels comprises:
a company description; and
a benefits section.

12. A system, comprising:
one or more processors; and
memory storing instructions that, when executed by the one or more processors, cause the system to:
obtain a set of segments from a job posting, wherein each segment in the set of segments comprises a portion of text in the job posting;
apply a model to the set of segments to produce a set of labels for the set of segments, wherein each label in the set of labels represents a type of information in the job posting; and
store the set of segments with the set of labels for use in matching the job posting to a candidate.

13. The system of claim 12, wherein obtaining the set of segments from the job posting comprises:
matching the text in the job posting to a set of patterns; and
using the matched set of patterns to generate the set of segments.

14. The system of claim 13, wherein using the matched set of patterns to generate the segments comprises:
using a pattern to define a segment; and
using another pattern to merge two segments into a single segment.

15. The system of claim 13, wherein the set of patterns comprises at least one of:
a tag;
a regular expression; and
a line break.

16. The system of claim 12, wherein applying the model to the set of segments to produce the set of labels for the set of segments comprises:
including one or more components of a segment as input to the model; and
obtaining, from the model, a label for the segment.

17. The system of claim 16, wherein the one or more components comprise at least one of:
a header;
a body;
a paragraph;
a list; and
a list item.

18. The system of claim 12, wherein using the set of segments with the set of labels for use in matching the job posting to the candidate comprises:
identifying a subset of the segments associated with a subset of the labels; and
using text in the subset of the segments to match the job posting to the candidate.

19. The system of claim 12, wherein the set of labels comprises:
a requirement;
a role;
a company description; and
a benefits section.

20. A non-transitory computer-readable storage medium storing instructions that when executed by a computer cause the computer to perform a method, the method comprising:
obtaining a set of segments from a job posting, wherein each segment in the set of segments comprises a portion of text in the job posting;
applying a model to the set of segments to produce a set of labels for the set of segments, wherein each label in the set of labels represents a type of information in the job posting; and
storing the set of segments with the set of labels for use in matching the job posting to a candidate.
